(19) United States
(12) Patent Application Publication
(10) Pub. No.: US 2013/0099609 A1
(43) Pub. Date: Apr. 25, 2013

(54) BRUSHLESS MOTOR

(71) Applicant: Mitsuba Corporation, Kiryu-shi (JP)

(72) Inventors: Hirotatsu Ikeno, Kiryu-shi (JP); Atsushi Okamoto, Kiryu-shi (JP); Yuya Ogawa, Kiryu-shi (JP)

(73) Assignee: MITSUBA CORPORATION, Kiryu-shi (JP)

(21) Appl. No.: 13/654,560

(22) Filed: Oct. 18, 2012

(30) Foreign Application Priority Data
Oct. 21, 2011 (JP) 2011-231652

(51) Int. Cl. H02K 5/22; H02K 11/00

(52) U.S. Cl. 310/52; 310/68 B; 310/71

(57) ABSTRACT

A brushless motor includes: a motor case 41 in which a cylindrical stator core 42 formed from steel plate by press molding is secured; a bracket 48 on one side in an axial direction of a motor case, a tip side of a rotary shaft 46 secured to a rotor 45 being rotatably supported by the bracket; and a housing member 51 on the other side in the axial direction of the motor case, a control device 52 for controlling the rotation of the rotor being accommodated in the housing member, the control device having a power-related circuit board 53 disposed on the side of a bottom 51b of the housing member and a control-related circuit board 54 disposed on the side of an opening of the housing member, semiconductor switching devices SW being disposed on the power-related circuit board in contact with the housing member.

### CROSS-REFERENCE TO RELATED APPLICATION

The present application claims priority from Japanese Patent Application No. 2011-231652 filed on Oct. 21, 2011, the content of which is hereby incorporated by reference into this application.

### TECHNICAL FIELD OF THE INVENTION

The present invention relates to a brushless motor having a stator core and a rotor that rotates in the stator core, and more particularly to a brushless motor suitable as an in-vehicle driving source.

### BACKGROUND OF THE INVENTION

Conventionally, an electric power steering apparatus (EPS) is mounted on a vehicle such as an automotive vehicle, and this electric power steering apparatus is adapted to assist a steering operation of a steering wheel by a driver. In the electric power steering apparatus, a brushless motor superior in controlled performance is adopted as a driving source, and as a result, by controlling the brushless motor in forward/backward directions with high precision in accordance with a steering angle of the steering wheel, the feeling of driving a vehicle is moderately received by the driver. As one example of a brushless motor that is adopted as a driving source in the electric power steering apparatus, a technique disclosed in Patent Document 1 (Patent Application Laid-Open Publication No.: 2008-174097, FIGS. 1 and 2) is known.

An electric motor (i.e., brushless motor) described in Patent Document 1 is provided with: a motor housing (motor case) made of aluminum and formed into a cylinder shape; and a stator (stator core) is secured in the motor housing. Furthermore, a rotor having an output shaft (rotary shaft) is rotatably provided in the stator. And three phase armature winding wires (coils) of U, V, and W are wound around the stator via an insulator, and by selectively supplying a driving current to these armature winding wires, the rotor (output shaft) is allowed to rotate in a forward or backward direction.

To the rear end side of the motor housing, a cover (housing member) made of aluminum is attached and secured via a circuit board for large current, and an insulated multi-layer circuit board (control device) is accommodated in this cover. On the circuit board for large current, semiconductor switching device, conductive plate and the like are mounted, and on the insulated multi-layer circuit board, electronic components such as semiconductor switching device as one of component parts of a power-related circuit, electrolytic capacitor, and shunt resistor are mounted.

However, according to the technique disclosed in Patent Document 1, each of the motor case and the housing member is made of aluminum, although the control device accommodated in the housing member is superior in heat radiation performance, after casting and forming the motor case and the housing member, it is necessary to grind an inner circumferential surface of the motor case (securing portion of stator core), surfaces to be brought into contact with each other, and the like to perform adjustment of their dimensions (secondary operation). Therefore, this leads to the complicated producing process of this motor, a problem about high production cost, the motor case and the housing member are inevitably increased in thickness, and as a result, a problem about an increased volume of this motor.

It is therefore an object of the present invention to provide a brushless motor reduced in production cost, even if the motor case is coupled to the housing member in which the control device is accommodated, and simplified in producing process, as well as ensuring the heat radiation performance of the control device, furthermore a control device is coupled to the motor case, and further improved in size and weight.

### SUMMARY OF THE INVENTION

A brushless motor according to the present invention has a stator core and a rotor that rotates in the stator core, the brushless motor comprising: a cylindrical motor case that is formed from steel plate by press molding is secured, and in which the stator core is secured; a supporting member that is provided on one side in an axial direction of the motor case, and by which a tip side of a rotary shaft secured to the rotor is rotatably supported; and a housing member that is provided on the other side in the axial direction of the motor case, in which a control device for controlling the rotation of the rotor is accommodated, and that is made of aluminum, wherein the control device comprises a power-related circuit board disposed on a bottom side of the housing member and a control-related circuit board disposed on an opening side of the housing member, power-related electronic components being disposed on the power-related circuit board in contact with the housing member.

In the brushless motor according to the present invention, a bottom wall is integrally formed on the other side in the axial direction of the motor case and formed with a through hole in which a base end side of the rotary shaft is inserted, and a magnetic rotary sensor for detecting the rotation of the rotary shaft is arranged on the base end side of the rotary shaft extending from the through hole.

In the brushless motor according to the present invention, the motor case is provided with a bearing supporting portion to which a bearing by which the base end side of the rotary shaft is rotatably supported is mounted, and a column-shaped space formed by the bottom wall and the bearing supporting portion so as to be offset toward the one side in the axial direction from the bottom wall, wherein a sensor magnet forming the magnetic rotary sensor is arranged in the column-shaped space.

In the brushless motor according to the present invention, a current collector to which an end portion of a coil wound around the stator core is connected is provided in an annular space formed between the stator core and the bottom wall, and the current collector and the control device are electrically connected to each other via a bottom hole partially formed on the bottom wall.

In the brushless motor according to the present invention, a fitting portion for coupling and axially aligning the motor case with the housing member, a route between an outside and an inside of the fitting portion is formed into a labyrinth shape.

In the brushless motor according to the present invention, the motor case and the housing member are coupled to each other with a sealing member being arranged in the route between the outside and the inside of the fitting portion.

In the brushless motor according to the present invention, a motor case side securing portion is anchored on the housing member side of an outer circumferential surface of the motor case.

In the brushless motor according to the present invention, the brushless motor serves as a driving source for an electric power steering apparatus.

The brushless motor according to the present invention comprises: a cylindrical motor case that is formed from steel plate by press molding is secured, and in which the stator core is secured; a supporting member that is provided on one side in an axial direction of the motor case, and by which a tip side of a rotary shaft secured to the rotor is rotatably supported; and a housing member that is provided on the other side in the axial direction of the motor case, in which a control device for controlling the rotation of the rotor is accommodated, and that is made of aluminum, wherein the control device comprises a power-related circuit board disposed on a bottom side of the housing member and a control-related circuit board disposed on an opening side of the housing member, power-related electronic components being disposed on the power-related circuit board in contact with the housing member. Thus, the brushless motor can be formed by the cylindrical motor case formed from steel plate by press molding and the bottomed housing member made of aluminum. Therefore, it is possible to sufficiently ensure the heat radiation performance of the control device, and in comparison with a conventional motor case made of aluminum, by eliminating the dimension adjusting operation (secondary operation) or the like, it is possible to simplify the producing process and consequently to reduce the production cost. Furthermore, in comparison with the conventional motor case made of aluminum and inevitably increased in thickness, it is possible to provide a motor case reduced in thickness by using a steel plate, and consequently the brushless motor can be improved in size and weight.

Since, in the brushless motor according to the present invention, a bottom wall is integrally formed on the other side in the axial direction of the motor case and formed with a through hole in which a base end side of the rotary shaft is inserted, and a magnetic rotary sensor for detecting the rotation of the rotary shaft is arranged on the base end side of the rotary shaft extending from the through hole. It is possible to shield a magnetic field generated upon driving the brushless motor from leaking externally by the bottom walls made of steel plate (magnetic material). Thus, it is possible to positively prevent erroneous detection of the magnetic rotary sensor, and consequently to enhance the detection precision of the magnetic rotary sensor.

Since, in the brushless motor according to the present invention, the motor case is provided with a bearing supporting portion to which a bearing by which the base end side of the rotary shaft is rotatably supported is mounted, and a column-shaped space formed by the bottom wall and the bearing supporting portion so as to be offset toward the one side in the axial direction from the bottom wall, wherein a sensor magnet forming the magnetic rotary sensor is arranged in the column-shaped space, it is possible to prevent the housing member from undesirably coming into contact with the sensor magnet, and consequently to preliminarily prevent the sensor magnet from coming off. Furthermore, it is possible to reduce the dimension of the maximum protruded portion in the axial direction of the motor case forming the brushless motor.

Since, in the brushless motor according to the present invention, a current collector to which an end portion of a coil wound around the stator core is connected is provided in an annular space formed between the stator core and the bottom wall, and the current collector and the control device are electrically connected to each other via a bottom hole partially formed on the bottom wall, upon assembling the brushless motor, by putting the housing member on the motor case, the current collector and the control device can be electrically connected to each other with ease.

Since, in the brushless motor according to the present invention, a fitting portion for coupling and axially aligning the motor case with the housing member, a route between an outside and an inside of the fitting portion is formed into a labyrinth shape, the route between the outside and the inside of the fitting portion can be formed as a labyrinth in a zigzag manner so that it becomes possible to make rain water, dusts, etc., hardly invade therein.

Since, in the brushless motor according to the present invention, the motor case and the housing member are coupled to each other with a sealing member being arranged in the route between the outside and the inside of the fitting portion, it is possible to ensure a further sufficient sealing performance by the labyrinth shape and the sealing member.

Since, in the brushless motor according to the present invention, a motor case side securing portion is anchored on a housing member side of an outer circumferential surface of the motor case, it is possible to provide a firmer secured state of the housing member that houses the control device on the other side in the axial direction of the motor case.

Since, in the brushless motor according to the present invention, the brushless motor serves as a driving source for an electric power steering apparatus, this brushless motor can be applied to an electric power steering apparatus that requires low noise, low vibration, low cost, and weight saving. Thus, this brushless motor can be readily mounted on a light vehicle and the like that inevitably require low cost and low fuel cost.

### BRIEF DESCRIPTIONS OF THE DRAWINGS

FIG. 1 is a schematic view explaining an electric power steering apparatus provided with a brushless motor according to one embodiment of the present invention;

FIG. 2 is a cross sectional view showing a detail structure of the brushless motor shown in FIG. 1;

FIG. 3 is an exploded perspective view showing the brushless motor shown in FIG. 1;

FIG. 4 is a view for explaining a procedure for fastening a motor case side securing portion with a motor case;

FIG. 5 is a partially enlarged cross sectional view showing a portion for connecting a housing member to the motor case;

FIG. 6 is an enlarged cross sectional view of a portion “A” bounded by a dashed circle shown in FIG. 5; and

FIG. 7 is a view for explaining a procedure for coupling the housing member with the motor case.

### DESCRIPTIONS OF THE PREFERRED EMBODIMENTS

Hereinafter, one embodiment of the present invention will be described in detail with reference to the drawings.

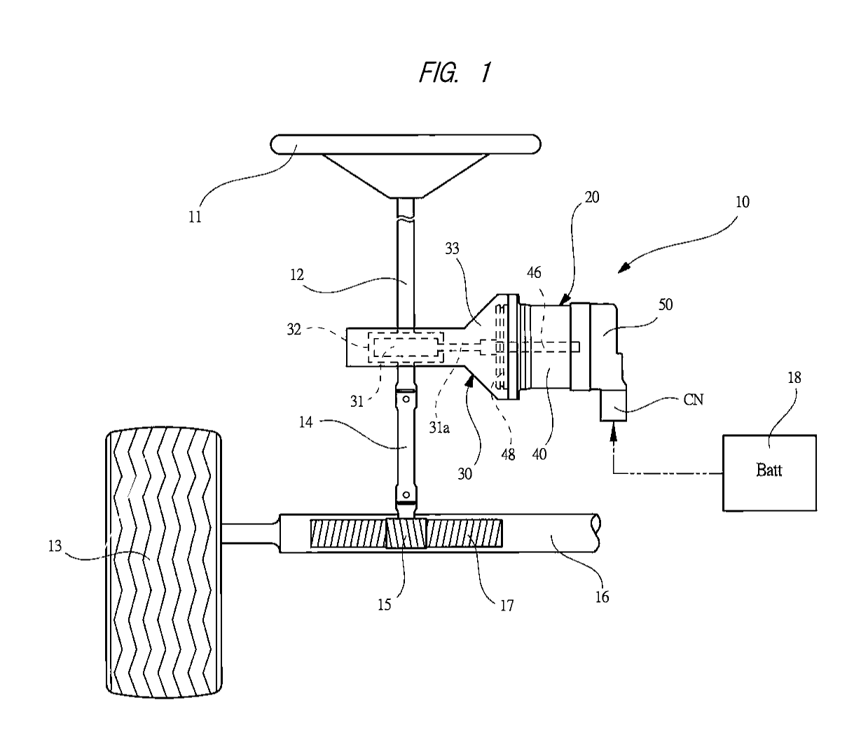

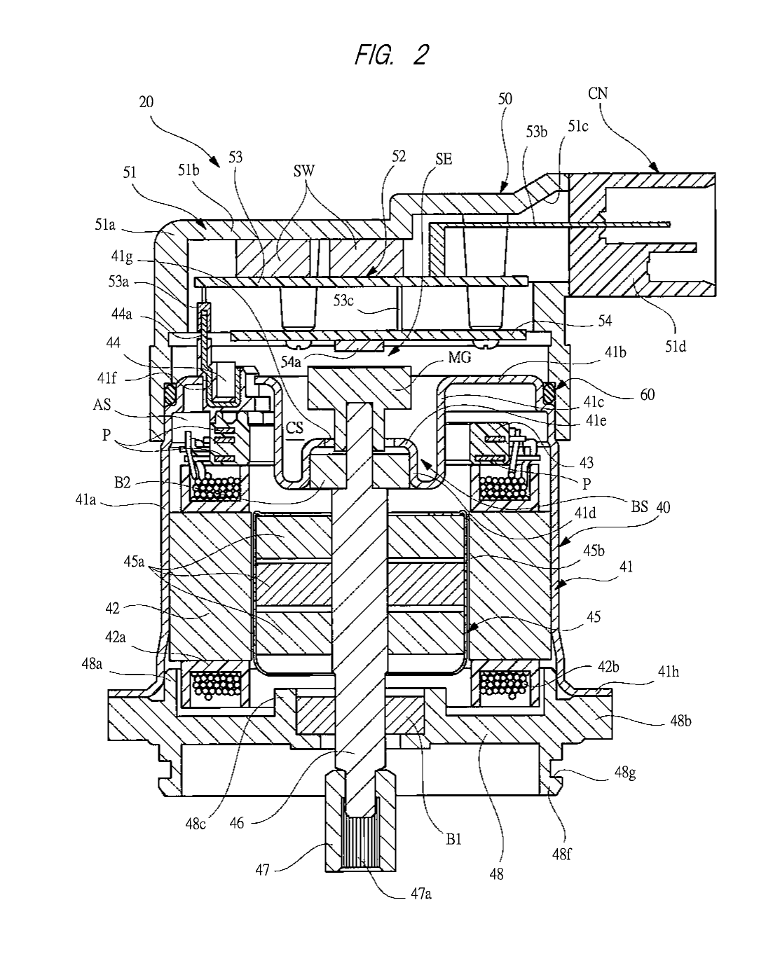

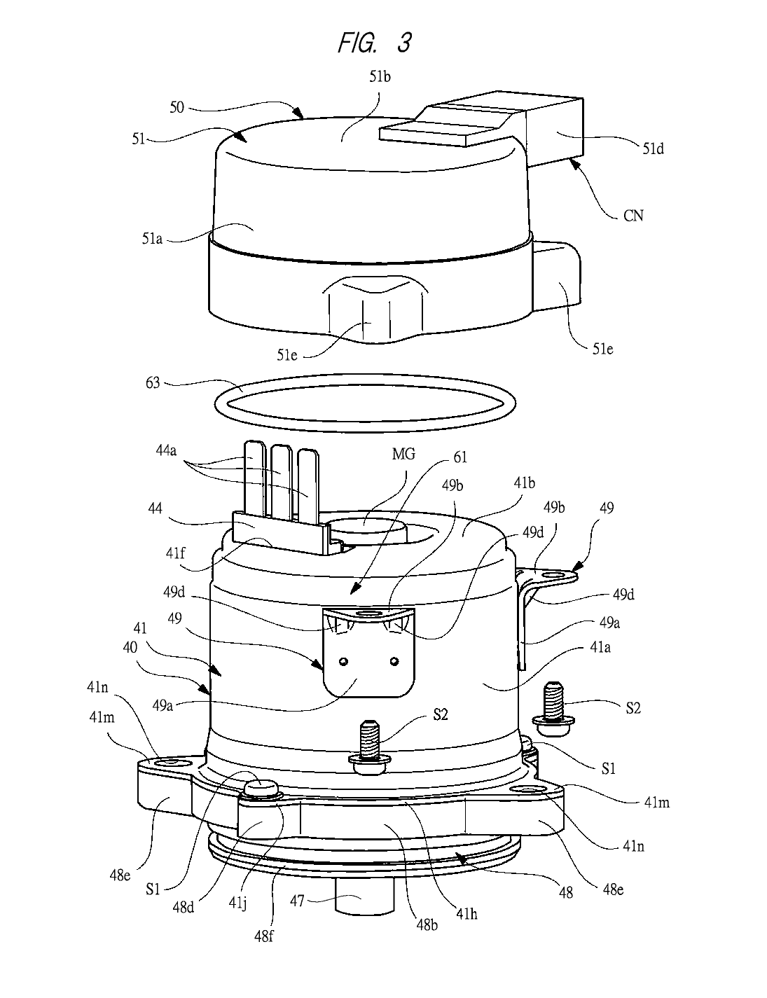

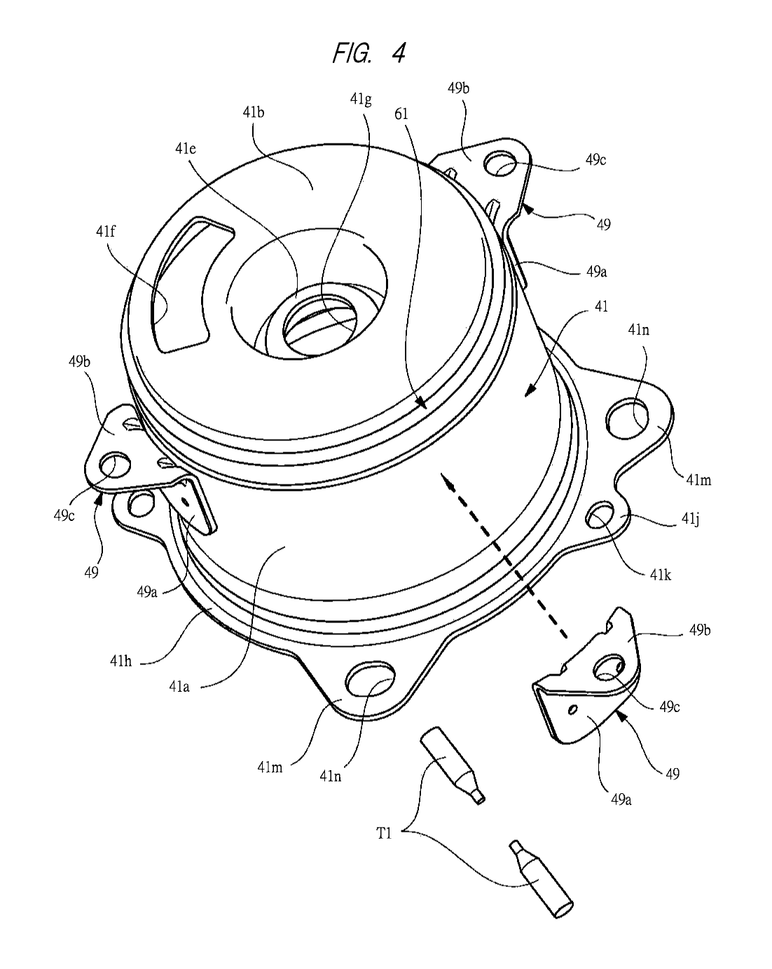

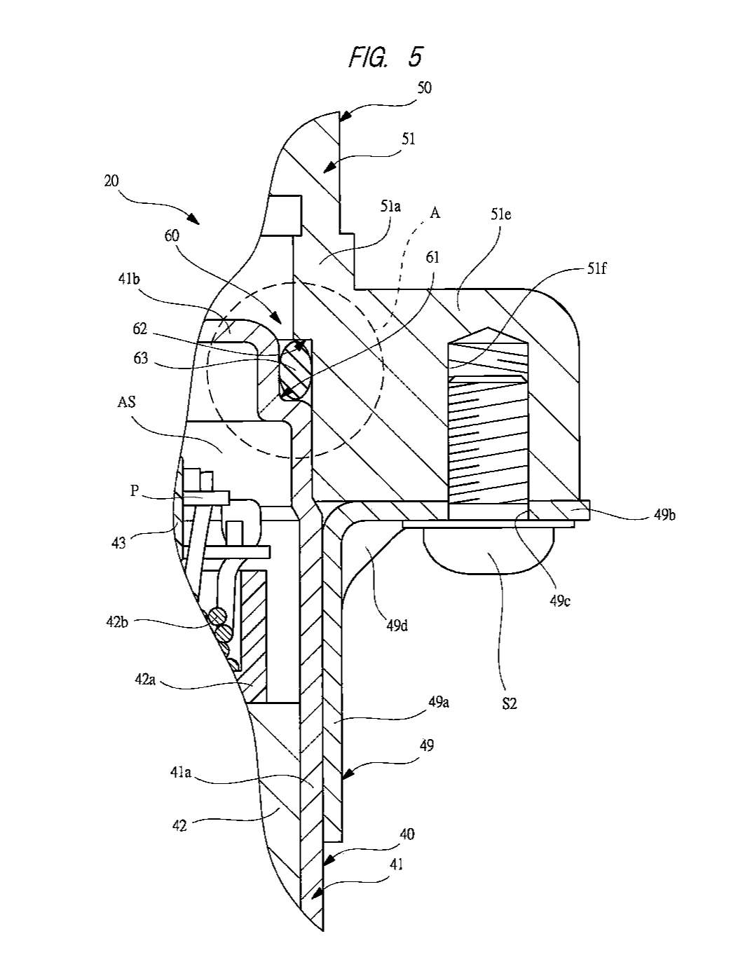

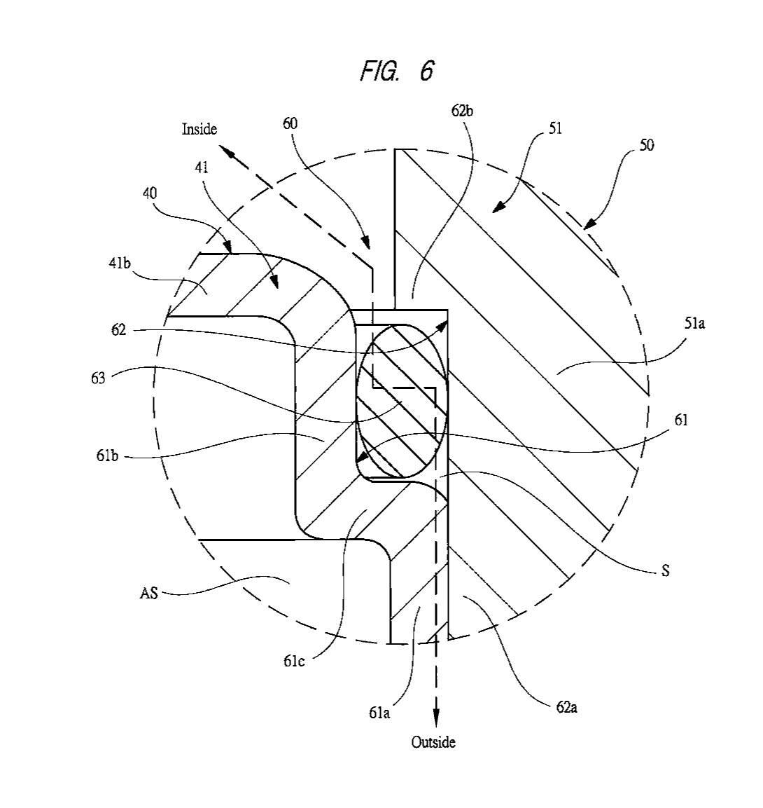

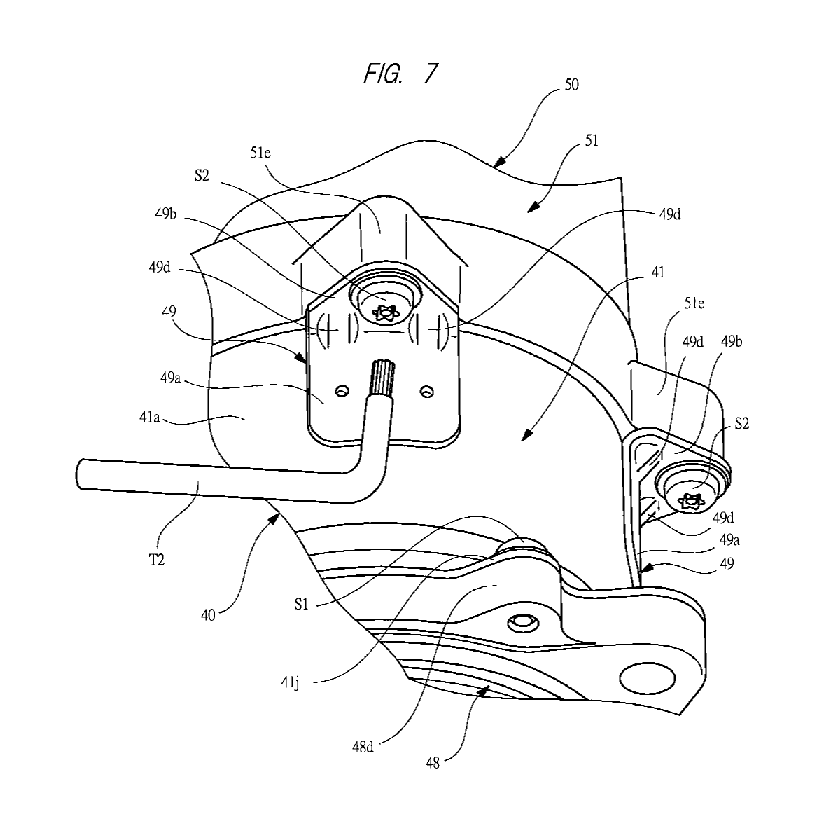

FIG. 1 is a schematic view explaining an electric power steering apparatus provided with a brushless motor according to one embodiment of the present invention, FIG. 2 is a cross sectional view showing a detail structure of the brushless motor shown in FIG. 1, FIG. 3 is an exploded perspective view showing the brushless motor shown in FIG. 1, FIG. 4 is a view for explaining a procedure for fastening a motor case side securing portion with a motor case, FIG. 5 is a partially enlarged cross sectional view showing a portion for connecting a housing member to the motor case, FIG. 6 is an enlarged cross sectional view of a portion “A” bounded by a dashed circle shown in FIG. 5, and FIG. 7 is a view for explaining a procedure for coupling the housing member with the motor case.

As shown in FIG. 1, in a body (not shown) of a vehicle such as an automobile, an electric power steering apparatus 10 is mounted, and the electric power steering apparatus 10 is adapted to assist a steering operation of front wheels 13 by a steering shaft 12 to which a steering wheel 11 to be operated by the driver is coupled. The electric power steering apparatus 10 is provided in the middle of the steering shaft 12, and mounted on a predetermined position inside a car room, not shown, so that a so-called column assist system is formed.

On the front wheels 13 side (on the lower side in the drawing) of the steering shaft 12, a pinion 15 is provided with a universal joint 14 interposed therebetween, and the pinion 15 is meshed with a rack 17 integrally formed in a tie rod 16. Additionally, these mechanisms are provided in a housing, not shown. With this arrangement, the steering operation (rotary motion) of the steering wheel 11 is converted to a shift (linear motion) in a lateral direction of the tie rod 16 via the steering shaft 12, the universal joint 14, the pinion 15 and the rack 17, and as a result, the front wheels 13 are steered leftward or rightward.

The electric power steering apparatus 10 is provided with a brushless motor 20 serving as a driving source and a speed-reduction mechanism 30 that reduces the rotation of the brushless motor 20 to provide a high torque. The brushless motor 20 is provided with a motor unit 40 and a controller unit 50, and the motor unit 40 and the controller unit 50 are mechanically coupled to each other into an integral unit.

A coupling connector CN is provided in the controller unit 50, and wiring from an in-vehicle battery 18 is electrically connected to the coupling connector CN. With this arrangement, by turning an ignition switch (not shown) on, a driving current is supplied to the controller unit 50. Furthermore, to the coupling connector CN, wiring or the like (not shown) from a torque sensor provided in the steering shaft 12 is also electrically connected. Thus, based upon a detection signal from the torque sensor, the controller unit 50 calculates the assist amount (number of revolutions, etc.) for the brushless motor 20, and supplies a driving current corresponding to the calculation result to the brushless motor 20.

The speed-reduction mechanism 30 is provided with a worm 31 that is provided so as to be integrally rotatable with a rotary shaft 46 of the brushless motor 20 via a coupling member 47, which will be described later, and a worm wheel 32 that is meshed with the worm 31 so as to be integrally rotated with the steering shaft 12. The worm 31 and the worm wheel 32 are accommodated in a reducer case 33, and the reducer case 33 is coupled to a bracket 48 serving as a supporting member of the brushless motor 20. With this arrangement, the rotation of the rotary shaft 46 of the brushless motor 20 is reduced to provide a high torque, and transmitted to the steering shaft 12 via the worm wheel 32.

As shown in FIG. 2, the motor unit 40 forming the brushless motor 20 is provided with a motor case 41 that is formed into a cylinder shape with a bottom by press-molding (deep-draw molding) a steel plate that is a magnetic material. The motor case 41 is constituted by a main body cylinder portion 41a, a first bottom wall (bottom wall) 41b, a second bottom wall (bottom wall) 41c, a third bottom wall (bottom wall) 41d and a fourth bottom wall (bottom wall) 41e, and one of the sides in an axial direction (lower side in the drawing) of the main body cylinder portion 41a is opened. On the other hand, the other side in the axial direction (upper side in the drawing) of the main body cylinder portion 41a is closed by the first to fourth bottom walls 41b, 41c, 41d and 41e. Furthermore, by the third and fourth bottom walls 41d and 41e, a bearing supporting unit BS of a second bearing B2, which will be described later, is formed, and the bearing supporting unit BS is disposed on the opening side of the motor case 41 from the first bottom wall 41b. Thus, an annular space AS is formed on the inner surface side of the first bottom wall 41b side of the motor case 41.

A stator core 42 formed into a ring shape is secured to the inside of the main body cylinder portion 41a, and onto the stator core 42, coils 42b having of U, V and W phases are wound around with predetermined winging methods and numbers of windings, with an insulator 42a made of a non-magnetic material such as a plastic material or the like being interpolated therebetween.

Between the stator core 42 and the first bottom wall 41b, that is, in the annular space AS, a bus-bar unit 43 serving as a current collector, formed into a ring shape in the same manner as in the stator core 42, is provided, and inside the bus-bar unit 43, a plurality of conductive plates P are formed and secured by an insert molding process. To one end of each of the conductive plates P, the end of each of the coils 42b having U, V and W phases is electrically connected, and to the other end of each of the conductive plates P, a terminal socket 44 provided with three connection terminals 44a (see FIG. 3) corresponding to the coils 42b having U, V and W phases is electrically connected.

In the terminal socket 44, the connection terminals 44a are formed and secured by an insert molding process, and the terminal socket 44 is allowed to penetrate a bottom hole 41f (see FIG. 4) having a virtually arc shape, which is partially formed on the first bottom wall 41b, and secured to the bottom hole 41f. With this structure, the coils 42b having of U, V and W phases and a control device 52 accommodated in a housing member 51 are electrically connected to each other via the bottom hole 41f with ease.

On the inside of the stator core 42, a rotor 45 is formed with a fine gap (air gap) being interposed therebetween, and the rotor 45 is adapted to rotate forwardly as well as backwardly, when a driving current is supplied to the coils 42b having U, V and W phases. The rotor 45 is formed by stacking a plurality of permanent magnets 45a each of which is formed into a ring shape, and the permanent magnets 45a are respectively covered with a rotor case 45b made of a thin steel plate.

In the rotation center of the rotor 45, that is, in the rotation center of the permanent magnets 45a, the rotary shaft 46 is allowed to penetrate and secured thereto, and the rotary shaft 46 is adapted to integrally rotate with the rotor 45. The tip side (lower side in the drawing) of the rotary shaft 46 is supported by a first bearing B1 formed on a bracket 48 that seals the opening side of the motor case 41 so as to freely rotate thereon. In this case, a ball bearing (not shown) is used as the first bearing B1.

The tip side of the rotary shaft 46 is extended outside the motor case 41 via the bracket 48, and to the tip portion extended outside the motor case 41 of the rotary shaft 46, a coupling member 47 having a cylinder shape is fitted to be secured therein. On the inside in a radial direction of the coupling member 47, a serration portion 47a composed of a plurality of concave/convex portions is formed, and to the serration portion 47a, a serration portion (not shown), formed on an outer circumferential surface of a base end (on the right side in FIG. 1) of a worm shaft 31a of the worm 31, is fitted to be secured therein; thus, the rotary shaft 46 and the worm 31 can be integrally rotated.

A base end (on the upper side of the drawing) of the rotary shaft 46 is allowed to penetrate a through hole 41g (see FIG. 4) formed on the fourth bottom wall 41e and extended outside the motor case 41, and to the base end portion of the rotary shaft 46 extended outside the motor case 41, a sensor magnet MG, provided with magnets magnetized to the two poles in the rotation direction so as to form a magnetic rotary sensor SE, is fitted and attached in a manner so as to integrally rotate together therewith. The sensor magnet MG is disposed in a column-shaped space CS formed by the second bottom wall 41c and the fourth bottom wall 41e (bearing supporting unit BS), with its most of portions being offset toward one side in the axial direction from the first bottom wall 41b of the motor case 41, and its end portion corresponding to a portion to be attached to the rotary shaft 46 is allowed to reach the inside of the through hole 41g; thus, with this arrangement, the dimension of the motor unit 40, that is, the dimension of the maximum protruded portion in the axial direction of the brushless motor 20 on the motor case 41 side, can be reduced, and simultaneously, the fitting strength of the sensor magnet MG can be properly maintained. Furthermore, for example, when the motor unit 40 and the controller unit 50 are coupled to each other, it is possible to suppress the controller unit 50 and the sensor magnet MG from being undesirably made in contact with each other, and consequently to preliminarily prevent the sensor magnet MG from coming off.

Furthermore, a second bearing (bearing) B2 is attached to the bearing supporting unit BS formed by the third and fourth bottom walls 41d and 41e so that the second bearing B2 supports the base end of the rotary shaft 46 so as to freely rotate thereon. In this case, as the second bearing B2, a ball bearing (not shown in detail) is used.

In this manner, between the inside and the outside of the motor case 41, the first to fourth bottom walls 41b, 41c, 41d and 41e, made of steel, are disposed, and this structure makes a magnetic field generated inside the motor case 41 hardly leak externally. Since adverse effects to the magnetic rotary sensor SE caused by the magnetic field are suppressed, the magnetic rotary sensor SE and the motor unit 40 can be disposed close to each other, thereby making it possible to suppress an increase of the length of the brushless motor in the axial direction as small as possible.

The one side in the axial direction of the motor case 41, that is, the opening side, is sealed by the bracket 48, made of aluminum, which is formed into a virtually disc shape by a forging process. The bracket 48 is provided with a fitting cylinder portion 48a for fitting and axially aligning the bracket 48 with the opening portion of the motor case 41, and an abut portion 48b that is allowed to abut against a flange portion 41h of the motor case 41. Threaded holes (not shown) are respectively formed on a plurality of first extended portions 48d on the bracket side, formed in a manner so as to extend externally in radial directions from the abut portion 48b of the bracket 48, and as shown in FIG. 3, a plurality of first extended portions 41j on the flange side, formed in a manner so as to extend externally in radial directions from the flange portion 41h of the motor case 41, and the first extended portions 48d on the bracket side are made abut against each other, and in this state, fastening screws 51 are thread-engaged by threaded holes 41k of the first extended portion 41j on the flange side so that the motor case 41 and the bracket 48 are coupled to each other. With this arrangement, the bracket 48 can be positioned with high precision relative to the motor case 41. Furthermore, in the center portion of the bracket 48, a bearing securing cylinder unit 48c through which the first bearing B1 is secured is formed so that the bracket 48 is allowed to support the rotary shaft 46 so as to freely rotate thereon through the first bearing B1.

Holes 41n are respectively formed on a plurality of second extended portions 41m on the flange side, formed in a manner so as to extend externally in radial directions from the flange portion 41h of the motor case 41. Furthermore, on the bracket 48, a plurality of second extended portions 48e on the bracket side are formed in a manner so as to extend externally in radial directions from the abut portion 48b, and on each of the second extended portions 48e on the bracket side, a hole (not shown) that is opposed to each of the holes 41n of the second extended portions 41m on the flange side is formed. Furthermore, the second extended portions 41m on the flange side and the second extended portions 48e on the bracket side are made abut against each other, and in this state, fastening screws (not shown) are allowed to penetrate from the holes 41n side of the second extended portions 41m on the flange side, and are thread joined with the reducer case 33 (see FIG. 1) so that the brushless motor 20 and the speed-reduction mechanism 30 are coupled to each other.

Reference numeral 48f represents an fitting portion to which the reducer case 33 of the speed-reduction mechanism 30 is inserted and fitted upon assembling the brushless motor 20 (bracket 48) into the speed-reduction mechanism 30, and an annular concave groove 48g for use in providing a sealing member (not shown), such as an O-ring or the like, for sealing the gap to the speed-reduction mechanism 30 is formed in this fitting portion 48f.

As shown in FIGS. 3 and 4, on an outer circumferential surface on the first to fourth bottom walls 41b, 41c, 41d and 41e sides of the motor case 41, that is, on an outer circumferential surface closer to the housing member 51 of the main body cylinder portion 41a, three motor case brackets (motor case side securing units) 49 are provided along the circumferential direction of the main body cylinder portion 41a. The motor case brackets 49 are provided along the circumferential direction of the main body cylinder portion 41a with intervals of about 90 degrees respectively, and respectively formed into the same shape.

Each of the motor case brackets 49 is formed into a virtually L shape by press-molding a steel plate that is the same material as that of the motor case 41, and is provided with an anchoring portion 49a to be anchored onto the main body cylinder portion 41a and a securing portion 49b to be secured onto a housing member side securing portion 51e of the housing member 51. On the securing portion 49b, screw holes 49c are formed so that securing screws S2, which are used for coupling the motor case 41 and the housing member 51 to each other to be secured, are inserted therethrough. Furthermore, between the anchoring portion 49a and the securing portion 49b, a pair of reinforcing ribs 49d are placed so that the strength of the motor case bracket 49 is enhanced by these and it is prevented from being deformed by an external force.

As shown in FIG. 4, the anchoring portion 49a is formed into a curved shape so as to have the same curvature radius as the curvature radius of the main body cylinder portion 41a so that the anchoring portion 49a is tightly made in contact with the main body cylinder portion 41a. Thus, no gap is produced between the anchoring portion 49a and the main body cylinder portion 41a. In this case, the motor case bracket 49 is anchored onto the motor case 41 by welding, and more specifically, as indicated by a broken-line arrow in the drawing, the anchoring portion 49a is made face to face with a predetermined portion of the main body cylinder portion 41a, and the anchoring portion 49a is then tightly made in contact with the main body cylinder portion 41a. In this state, corresponding portions are subjected to a spot welding process by using a welding tool T1.

Additionally, since the motor case bracket 49 and the motor case 41 are formed by using a steel plate of the same material, the two members are easily anchored to each other firmly. In this case, however, as the anchoring means for anchoring the motor case bracket 49 and the motor case 41 to each other, not limited to the above-mentioned spot welding process, for example, another welding method, such as an arc welding, may be used. Furthermore, as long as a required anchoring strength can be obtained, another anchoring means, such screw members or the like, may be used.

With this arrangement, since a firmly anchored state between the motor case 41 and the motor case bracket 49 is obtained, a firmly coupled state between the motor case 41 and the housing member 51 is also prepared so that generation of noises, vibrations, etc. from the coupled portion can be effectively suppressed.

As shown in FIG. 2, the controller unit 50 forming the brushless motor 20 is provided with the housing member 51 made of aluminum. The housing member 51 is provided on the other side in the axial direction of the motor case 41 (upper side in the drawing), and is formed into a cylinder shape with a bottom, which is provided with a cylinder portion 51a and a bottom portion 51b. Inside of the housing member 51, a control device 52 for use in drive-controlling the rotor 45 of the motor unit 40 is accommodated.

A terminal drawing hole 51c is formed on the cylinder portion 51a, and the terminal drawing hole 51c has an opening in a direction orthogonal to the axial direction of the rotary shaft 46. To the terminal drawing hole 51c, a connector connecting unit 51d made of a resin for use in forming the coupling connector CN is attached, and to the connector connecting unit 51d, an in-vehicle battery 18 (see FIG. 1) and a car-body side connector (not shown) having a wiring from the torque sensor is connected.

As shown in FIG. 3, on the outer circumferential surface closer to the motor case 41 of the cylinder portion 51a, three housing member side securing portions 51e (only two of them are shown in the drawing) are formed so as to protrude in radial directions of the cylinder portion 51a in a manner so as to follow the circumferential direction of the cylinder portion 51a. The housing member side securing portions 51e are provided along the circumferential direction of the main body cylinder portion 41a with intervals of about 90 degrees respectively so as to correspond to the motor case brackets 49. Each of the housing member side securing portions 51e is integrally molded together with each of the cylinder portions 51a and all of them have the same shape. Furthermore, as shown in FIG. 5, on each of the housing member side securing portions 51e, a female screw portion 51f is formed with which a fixed screw S2 for use in coupling the motor case 41 and the housing member 51 to each other to be secured is screw-engaged.

As shown in FIG. 2, the control device 52 to be accommodated in the housing member 51 is provided with a power-related circuit board 53 disposed on the bottom portion 51b side (on the upper side in the drawing) of the housing member 51 and a control-related circuit board 54 disposed on the opening side (on the lower side in the drawing) of the housing member 51. On the power-related circuit board 53, a plurality of semiconductor switching devices SW serving as power-related electronic components, and other electronic components such as capacitors and shunt resistors (none of them are shown) are mounted. Furthermore, the semiconductor switching devices SW are disposed so as to be made in contact with the bottom portion 51b so that heat generated upon driving the brushless motor 20 is externally radiated through the housing member 51. In other words, the housing member 51 has a function as a heatsink, and the housing member 51 is made of aluminum so that the function as the heatsink that externally radiates heat from the power-related electronic components easily is provided.

On the power-related circuit board 53, three female-type terminals 53a (only one of which is shown in the drawing) to be plugged into the connection terminals 44a on the motor unit 40 side, which are electrically connected, are provided. Upon coupling the motor case 41 and the housing member 51 to each other, the connection terminals 44a are plugged into the female-type terminals 53a correspondingly.

On the power-related circuit board 53, the base end side of a plurality of connection terminals 53b (only one of which is shown in the drawing), which is electrically connected, is provided, and the other end side of the connection terminals 53b is exposed to the inside of the connector connecting unit 51d via the terminal drawing hole 51c. Furthermore, by connecting the car-body side connectors to the connector connecting unit 51d, the connection terminals 53b are electrically connected to wirings of the in-vehicle battery 18 (see FIG. 1) and the torque sensor.

To the power-related circuit board 53, one end side of a plurality of connection lines 53c (only one of which is shown in the drawing) is electrically connected, and the other end side of the connection lines 53c is electrically connected to the control-related circuit board 54. Thus, power is supplied to the control-related circuit board 54, and control signals from the control-related circuit board 54 are transmitted to the power-related circuit board 53.

The control-related circuit board 54 is disposed face to face with the first bottom wall 41b of the motor case 41, and in a virtually center portion on the first bottom wall 41b side on the control-related circuit board 54, an MR sensor 54a forming the magnetic rotary sensor SE is mounted. In this case, the magnetic rotary sensor SE is constituted by the MR sensor 54a and a sensor magnet MG attached to the rotary shaft 46, and the two members are disposed to be opposed to each other with a fine distance (air gap) interpolated therebetween. The magnetic rotary sensor SE is of a non-contact type, and the MR sensor 54a generates a pulse signal by the rotation of the sensor magnet MG so that the corresponding pulse signal is transmitted to a CPU (not shown) mounted on the control-related circuit board 54. That is, by counting the number of pulses from the pulse signal from the MR sensor 54a, the CPU can calculate the rotation angle of the rotary shaft 46, and by examining the timing of appearance of the pulse signals, the CPU can calculate the number of revolutions of the rotary shaft 46.

As shown in FIGS. 5 and 6, an “INROU” fitting portion 60 (hereinafter simply referred to as “fitting portion”) that couples and axially aligns the motor case 41 with the housing member 51 is provided between the motor case 41 and the housing member 51. The fitting portion 60 is provided with a motor case-side step portion 61, a housing member-side step portion 62, and an O-ring (sealing member) 63 placed between the step portions 61 and 62, and is allowed to function as a sealing mechanism for preventing rain water, dusts, etc. from invading therein from the outside. Thus, the fitting portion 60 prevents damages to the control device 52 and degradation of detection precision in the magnetic rotary sensor SE. Furthermore, in the present embodiment, the first to fourth bottom walls 41b, 41c, 41d and 41e are provided on the fitting portion 60 side of the motor case 41 so that it is possible to positively prevent rain water, dusts, etc. from entering the inside of the motor case 41 by the first to fourth bottom walls 41b, 41c, 41d and 41e.

The motor case-side step portion 61 that forms the fitting portion 60 on the motor case 41 side is formed close to the housing member 51 (close to the first bottom wall 41b) of the main body cylinder portion 41a, and has a ring shape that recesses inward in the radial direction of the motor case 41. The motor case-side step portion 61 is provided with a motor case-side fitting portion 61a that forms the outer circumferential surface of the motor case 41 and a small diameter portion 61b that is formed on the other side in the axial direction (on the upper side in the drawing) farther from the motor case-side fitting portion 61a, and has a diameter smaller than that of the motor case-side fitting portion 61a. Furthermore, between the motor case-side fitting portion 61a and the small diameter portion 61b, a wall portion 61c that extends in a radial direction of the motor case 41 is placed.

The housing member-side step portion 62 forming the fitting portion 60 on the housing member 51 side is formed closer to the motor case 41 (closer to the housing member-side securing portion 51e) of the cylinder portion 51a, and has a ring shape that recesses outward in the radial direction of the housing member 51. The housing member-side step portion 62 is provided with a housing member-side fitting portion 62a that is externally fitted to the motor case-side fitting portion 61a and a protruding portion 62b that is placed on the other side (on the upper side in the drawing) in the axial direction farther from the housing member-side fitting portion 62a, and protrudes toward the small diameter portion 61b. In this case, the height of protrusion of the protruding portion 61b is set to be smaller than the length dimension of the wall portion 61c formed on the motor case 41 side. In other words, the height of protrusion of the protruding portion 61b is set to such a height dimension as not to be made in contact with the small diameter portion 61b (motor case 41).

The O-ring 63 is made from an elastic material (rubber material or the like) having a flexibility, and formed into a round shape in its cross section. The O-ring 63 is disposed between the motor case-side step portion 61 and the housing member-side step portion 62, that is, in a route between the outside and the inside of the fitting portion 60, in a pressed state (elastically deformed state) in the radial direction. More specifically, the O-ring 63 is disposed in the annular space S formed by the motor case-side fitting portion 61a, the small diameter portion 61b, the wall portion 61c, the housing member-side fitting portion 62a and the protruding portion 62b. With this arrangement, the O-ring 63 is made tightly in contact with both of the motor case-side step portion 61 and the housing member-side step portion 62 so that the gap between the motor case 41 and the housing member 51 is positively sealed tightly. In this case, since the O-ring 63 is capable of being elastically deformed, the error in the dimension in the radial direction of the motor case-side step portion 61 and the housing member-side step portion 62 can be absorbed.

Furthermore, by allowing the motor case-side step portion 61 that recesses inward in the radial direction and the housing member-side step portion 62 that recesses outward in the radial direction to be disposed face to face with each other, the route between the outside and the inside of the fitting portion 60 is easily formed into a labyrinth shape, that is, in a zigzag manner (see a broken-line arrow in FIG. 6) like a maze, with the result that it becomes possible to sufficiently prevent rain water, dusts, etc., from invading from the outside to the inside of the fitting portion 60. Therefore, depending on the specification (degree) of waterproof/dustproof functions of the brushless motor 20, only the labyrinth shape is sufficient, or in the case when, for example, this brushless motor 20 is disposed in a water-prone environment or a dust-prone environment, the O-ring 63 can be appropriately selected and disposed.

In this case, the positioning of the motor case 41 and the housing member 51, that is, the mounting depth of the housing member 51 relative to the motor case 41, is determined depending on the contact between the motor case bracket 49 of the motor case 41 and the housing member-side securing portion 51e of the housing member 51. With this arrangement, the O-ring 63 is prevented from being squashed to be damaged by the wall portion 61c of the motor case-side step portion 61 and the protruding portion 62b of the housing member-side step portion 62.

Next, referring to Figures, the sequence of assembling process of the brushless motor 20 to be formed as described above will be described in detail.

First, as shown in FIG. 3, a motor unit 40 and a controller unit 50 respectively assembled in different assembling processes are prepared. Furthermore, an O-ring 63, three securing screws S2 and a fastening tool T2 (see FIG. 7) for use in fastening the securing screws S2 are prepared. In this case, the fastening screws S2 are special screws, and are not general-use plus-type screws or minus-type screws, but have a screw head having a star-shaped concave portion, as shown in FIG. 7. Therefore, the fastening tool T2 is a special tool exclusively used for the securing screws S2. Thus, the brushless motor 20 has a structure that is not easily disassembled (non-disassemble type).

Furthermore, as shown in FIG. 3, the O-ring 63 is attached to the motor case-side step portion 61 of the motor unit 40, with the axis of the motor unit 40 and the axis of the O-ring 63 being made coincident with each other. In order to ensure the sealing property of the O-ring 63, provision is made so as not to cause a twisting force in the O-ring 63. Thereafter, the controller unit 50 is put on the motor unit 40, with the axis of the motor unit 40 to which the O-ring 63 is attached and the axis of the controller unit 50 being made coincident with each other. In this case, the housing member-side securing portions 51e of the controller unit 50 are made face to face with the motor case brackets 49 of the motor unit 40. Then, as shown in FIG. 2, the female-type terminals 53a of the control device 52 and the connection terminals 44a of the terminal socket 44 are made face to face with each other.

Next, when the controller unit 50 is coupled to the motor unit 40, the housing member-side fitting portion 62a of the housing member 51 is fitted (externally-fitted) to the motor case-side fitting portion 61a of the motor case 41. Thus, the O-ring 63 is accommodated in the space S surrounded by the motor case-side step portion 61 and the housing member-side step portion 62 so that the fitting portion 60 is allowed to function as a sealing mechanism (see FIG. 6). Furthermore, the fitting portion 60 functions as the sealing mechanism, and the connection terminals 44a are also inserted into the female-type terminals 53a so as to be electrically connected with each other.

Thereafter, by proceeding the fitting processes between the motor case 41 and the housing member 51, the housing member-side securing portions 51e of the housing member 51 and the securing portion 49b of the motor case brackets 49 are made in contact with each other. Thus, the fitting process of the housing member 51 to the motor case 41 is completed. Upon completion of the fitting process of the housing member 51 into the motor case 41, the spaced distance (see FIG. 2) between the sensor magnet MG of the magnetic rotary sensor SE and the MR sensor 54a is optimized so that the two members are disposed face to face with each other with a fine distance (air gap) interpolated therebetween.

Furthermore, as shown in FIGS. 5 and 7, with the securing screws S2 being inserted into the screw holes 49c of the motor case brackets 49, the securing screws S2 are respectively thread-engaged with the female screw portions 51f of the housing member-side securing portions 51e by using the fastening tool T2. Consequently, the motor case 41 and the housing member 51 are coupled to each other, and the motor unit 40 and the controller unit 50 are integrally formed into one unit so that a brushless motor 20 is completed.

Thereafter, the completed brushless motor 20 is coupled to a reducer case 33 of the speed-reduction mechanism 30 by using fastening screws (not shown) which are allowed to pass through holes 41n of a plurality of flange-side second extended portions 41m formed so as to be extended from the flange portion 41h of the motor case 41 outward in the radial direction and holes (not shown) of a plurality of bracket-side second extended portions 48e formed so as to be extended from the abut portion 48b of the bracket 48 outward in the radial direction.

As described above in detail, in accordance with the brushless motor 20 of the present embodiment, a steel plate is press-formed into a cylinder shape, and the motor case 41 with the stator core 42 secured inside thereof is provided therein, and on one of the sides in the axial direction of the motor case 41, a bracket 48 that supports the tip side of the rotary shaft 46 secured to the rotor 45 so as to freely rotate thereon is provided, and on the other side in the axial direction of the motor case 41, a housing member 51, which houses the control device 52 that drive-controls the rotor 45 and is made of aluminum and formed into a cylinder shape with a bottom, is provided, and the control device 52 is provided with the power-related circuit board 53 disposed on the bottom 51b side of the housing member 51, and the control-related circuit board 54 disposed on the opening side of the housing member 51, with the semiconductor switching devices SW being disposed on the power-related circuit board 53 in contact with the housing member 51.

With this arrangement, the brushless motor 20 can be formed by the motor case 41 that is formed by press-molding a steel plate into a cylinder shape and the housing member 51 that is made of aluminum and formed into a cylinder shape with a bottom. Therefore, the heat radiation performance of the control device 52 can be sufficiently ensured, and in comparison with a conventional motor case made of aluminum, dimension adjusting operations (secondary operations) or the like can be eliminated so that it is possible to simplify the producing process and consequently to reduce the production cost. Furthermore, in comparison with the conventional motor case made of aluminum that inevitably requires a high thickness, the motor case 41 can be made thinner because a steel plate is utilized, and the brushless motor 20 can be consequently reduced in size and weight.

Furthermore, in accordance with the brushless motor 20 of the present embodiment, on the other side in the axial direction of the motor case 41, the first to fourth bottom walls 41b, 41c, 41d and 41e are integrally formed, with the through hole 41g to which the base end of the rotary shaft 46 is inserted being formed on the fourth bottom wall 41e, and on the base end of the rotary shaft 46 extended from the through hole 41g, the magnetic rotary sensor SE for use in detecting the rotation of the rotary shaft 46 is disposed so that it is possible to shield a magnetic field generated upon driving the brushless motor 20 from leaking externally by the first to fourth bottom walls 41b, 41c, 41d and 41e made of a steel plate (magnetic material). Thus, it is possible to positively prevent erroneous operations of the magnetic rotary sensor SE, and consequently to suppress the detection precision of the magnetic rotary sensor SE from being lowered.

Furthermore, in accordance with the brushless motor 20 of the present embodiment, the bearing supporting unit BS to which the second bearing B2 for use in supporting the base end of the rotary shaft 46 so as to freely rotate thereon is attached is formed in the motor case 41, and the column-shaped space CS formed by the second bottom wall 41c and the bearing supporting unit BS is placed so as to be offset toward the one side in the axial direction from the first bottom wall 41b, with the sensor magnet MG forming the magnetic rotary sensor SE being disposed inside the column-shaped space CS, so that upon coupling the motor case 41 and the housing member 51 to each other, it is possible to prevent the housing member 51 and the sensor magnet MG from being undesirably made in contact with each other, and consequently to preliminarily prevent the sensor magnet MG from coming off. The dimension of the maximum protruded portion in the axial direction on the motor case 41 side (motor unit 40) forming the brushless motor 20 can be reduced.

Furthermore, in accordance with the brushless motor 20 of the present embodiment, the bus-bar unit 43 to which the end of the coil 42b that is wound around the stator core 42 is connected is provided in the annular space AS formed between the stator core 42 and the first bottom wall 41b, and through the bottom hole 41f partially formed on the first bottom wall 41b, the bus-bar unit 43 and the control device 52 are electrically connected with each other; therefore, upon assembling the brushless motor 20, by putting the housing member 51 on the motor case 41, the bus-bar unit 43 and the control device 52 can be easily electrically connected to each other.

Furthermore, in accordance with the brushless motor 20 of the present embodiment, the fitting portion 60 that couples the motor case 41 and the housing member 51 with each other is provided between the motor case 41 and the housing member 51, and since the route between the outside and the inside of the fitting portion 60 with each other is formed into a labyrinth shape, the route between the outside and the inside of the fitting portion 60 can be formed as a labyrinth in a zigzag manner so that it is possible to make rain water, dusts, etc. hardly invade therein.

Furthermore, in accordance with the brushless motor 20 of the present embodiment, since the motor case 41 and the housing member 51 is coupled to each other, with the O-ring 63 being disposed in the route between the outside and the inside of the fitting portion 60 with each other, a further sufficient sealing property can be ensured by the labyrinth shape and the O-ring 63.

Furthermore, in accordance with the brushless motor 20 of the present embodiment, since the motor case bracket 49 to be secured to the housing member-side securing portion 51e formed on the housing member 51 is anchored onto the outer circumferential surface closer to the housing member 51 of the motor case 41, the housing member 51 housing the control device 52 is more firmly secured onto the other side in the axial direction of the motor case 41.

Furthermore, in accordance with the brushless motor 20 of the present embodiment, since the brushless motor 20 is utilized as a driving source for the electric power steering apparatus 10, the resulting device can be applied to an electric power steering apparatus (EPS) that requires low noise, low vibration, low cost and weight saving. Thus, the resulting device can be readily mounted on a light vehicle and the like that inevitably require low cost and low fuel cost.

The present invention is not intended to be limited by the above embodiment, and it is needless to say that various modifications may be made therein within the scope without departing from the gist of the present invention. For example, the above embodiment has exemplified a system in which a brushless motor 20 is applied to an electric power steering apparatus 10 of a column assist type provided in the middle of a steering shaft 12; however, the present invention is not limited by this, and may be applied to another electric power steering apparatus of a type for assisting a pinion 15 (see FIG. 1) or a type for assisting a tie rod 16 (see FIG. 1).

Furthermore, the above embodiment has exemplified a system in which the brushless motor 20 is used for a driving source for an electric power steering apparatus 10; however, the present invention is not limited by this, and may be applied to, for example, a driving source or the like of an engine auxiliary device, such as an oil pump motor or the like.

What is claimed is:

1. A brushless motor having a stator core and a rotor that rotates in the stator core, the brushless motor comprising:
a motor case in which the stator core is secured;
a supporting member that is provided on one side in an axial direction of the motor case, and by which a tip side of a rotary shaft secured to the rotor is rotatably supported; and
a housing member that is provided on the other side in the axial direction of the motor case, in which a control device for controlling the rotation of the rotor is accommodated, and that functions as a heatsink,
wherein the control device comprises a power-related circuit board disposed on a bottom side of the housing member and a control-related circuit board disposed on an opening side of the housing member, power-related electronic components being disposed on the power-related circuit board in contact with the housing member.

2. The brushless motor according to claim 1, wherein a bottom wall is integrally formed on the other side in the axial direction of the motor case and formed with a through hole in which a base end side of the rotary shaft is inserted, and a magnetic rotary sensor for detecting the rotation of the rotary shaft is arranged on the base end side of the rotary shaft extending from the through hole.

3. The brushless motor according to claim 2, wherein the motor case is provided with a bearing supporting portion to which a bearing by which the base end side of the rotary shaft is rotatably supported is mounted, and a column-shaped space formed by the bottom wall and the bearing supporting portion so as to be offset toward the one side in the axial direction from the bottom wall, wherein a sensor magnet forming the magnetic rotary sensor is arranged in the column-shaped space.

4. The brushless motor according to claim 2, wherein a current collector to which an end portion of a coil wound around the stator core is connected is provided in an annular space formed between the stator core and the bottom wall, and the current collector and the control device are electrically connected to each other via a bottom hole partially formed on the bottom wall.

5. The brushless motor according to claim 3, wherein a current collector to which an end portion of a coil wound around the stator core is connected is provided in an annular space formed between the stator core and the bottom wall, and the current collector and the control device are electrically connected to each other via a bottom hole partially formed on the bottom wall.

6. The brushless motor according to claim 1, wherein a fitting portion for coupling and axially aligning the motor case with the housing member, a route between an outside and an inside of the fitting portion is formed into a labyrinth shape.

7. The brushless motor according to claim 2, wherein a fitting portion for coupling and axially aligning the motor case with the housing member, a route between an outside and an inside of the fitting portion is formed into a labyrinth shape.

8. The brushless motor according to claim 6, wherein the motor case and the housing member are coupled to each other with a sealing member being arranged in the route between the outside and the inside of the fitting portion.

9. The brushless motor according to claim 7, wherein the motor case and the housing member are coupled to each other with a sealing member being arranged in the route between the outside and the inside of the fitting portion.

10. The brushless motor according to claim 1, wherein a motor case side securing portion is anchored on the housing member side of an outer circumferential surface of the motor case.

11. The brushless motor according to claim 2, wherein a motor case side securing portion is anchored on the housing member side of an outer circumferential surface of the motor case.

12. The brushless motor according to claim 1, wherein the brushless motor serves as a driving source for an electric power steering apparatus.

13. The brushless motor according to claim 2, wherein the brushless motor serves as a driving source for an electric power steering apparatus.

14. The brushless motor according to claim 3, wherein the brushless motor serves as a driving source for an electric power steering apparatus.
